(19) United States
(12) Patent Application Publication
(10) Pub. No.: US 2006/0015635 A1
(43) Pub. Date: Jan. 19, 2006

(54) Method and apparatus for handling address resolution protocol requests for a device having multiple interfaces

(75) Inventors: Lilian Sylvia Fernandes, Austin, TX (US); Vinit Jain, Austin, TX (US); Rashmi Narasimhan, Austin, TX (US); Venkat Venkatsubra, Austin, TX (US)

Correspondence Address: IBM CORPORATION (WMA);C/O WILLIAMS, MORGAN & AMERSON, P.C., 10333 RICHMOND, SUITE 1100, HOUSTON, TX, 77042, US

(73) Assignee: INTERNATIONAL BUSINESS MACHINES CORPORATION, ARMONK, NY (US)

(21) Appl. No.: 10/870,525

(22) Filed: Jun. 17, 2004

(51) Int. Cl. G06F 15/16

(52) U.S. Cl. 709/232

(57) ABSTRACT

The present invention provides a method and apparatus for handling address resolution protocol requests for a device having multiple interfaces. The method comprises receiving a message transmitted by a remote device to a host. The message includes a request to provide a value representative of an address associated with the host and the message includes a value representative of an address associated with the remote device. The method further comprises comparing at least a portion of the value representative of the address associated with the remote device to a value stored in an address field on a storage unit and discarding the message in response to determining that at least the portion of the value representative of the address associated with the remote device is substantially equal to the value stored in the address field.

### BACKGROUND OF THE INVENTION

1. Field of the Invention

The invention generally relates to network communications, and, in particular, to handling Address Resolution Protocol (ARP) requests for a device having multiple interfaces.

2. Description of the Related Art

Network applications usually bind to a physical network interface for Transmission Control Protocol/Internet Protocol (TCP/IP) communications. This allows the application to use an IP address (belonging to that physical interface) to identify the host on which the application is executing. If the interface fails, the application can no longer communicate, and TCP/IP sessions are lost.

A virtual IP address (VIPA) reduces a host's dependency upon individual network interfaces. The VIPA adds a layer of protection against network connection failure. This is because a VIPA is configured on a TCP/IP stack rather than a physical adapter, and is therefore not associated with any particular endpoint device. Incoming packets are sent to a system's VIPA address, but all packets travel through the real network interfaces. With the use of a VIPA and routing protocols within a network providing automatic reroute, recovery from failures occurs without little or no disruption to the existing user connections that are using the virtual interface as long packets can arrive through another physical interface. For this reason, systems using a VIPA are more reliable because adapter outages have a lesser impact on active connections.

While the use of a VIPA adds a layer of protection against network connection failure on a given system, such a system typically does not efficiently handle ARP broadcast requests. For example, consider a host (Host A) that has multiple physical (real) interfaces that have one associated virtual IP address. If another host (Host B) on the same subnet as Host A sends an ARP request for the VIPA, all the real interfaces on that subnet will pick up the packet, including the interfaces of Host A. Each of the interfaces of the Host A thus detect that the ARP request was indeed for an address on this host (the VIPA). Hence, each interface tries to respond to the ARP request with its Medium Access Control (MAC) address. This causes the recipient, Host B, to get multiple replies from Host A, and, as a result, may cause ARP flooding. Accordingly, a multi-interface host that is configured with a VIPA cannot efficiently handle ARP requests.

The present invention is directed to addressing, or at least reducing, the effects of, one or more of the problems set forth above.

### SUMMARY OF THE INVENTION

In one aspect of the instant invention, a method is provided for handling address resolution protocol requests for a device having multiple interfaces. The method comprises receiving a message transmitted by a remote device to a host. The message includes a request to provide a value representative of an address associated with the host and the message includes a value representative of an address associated with the remote device. The method further comprises comparing at least a portion of the value representative of the address associated with the remote device to a value stored in an address field on a storage unit and discarding the message in response to determining that at least the portion of the value representative of the address associated with the remote device is substantially equal to the value stored in the address field.

In another aspect of the instant invention, an apparatus is provided for handling address resolution protocol requests for a device having multiple interfaces. The apparatus comprises at least a first interface, a second interface and a control unit. The control unit is adapted to receive a message transmitted by a remote device to a host. The message includes a request to provide a value representative of an address associated with the host and message includes a value representative of an address associated with the remote device. The apparatus further comprises comparing at least a portion of the value representative of the address associated with the remote device to a value stored in an address field on a storage unit and discard the message in response to determining that at least the portion of the value representative of the address associated with the remote device is substantially equal to the value stored in the address field.

In another aspect of the instant invention, an article comprising one or more machine-readable storage media containing instructions is provided for handling address resolution protocol requests for a device having multiple interfaces. The instructions, when executed, enable a processor to receive a message transmitted by a remote device over a first interface of a host. The message includes a request to provide an address associated with the host and the message includes an address associated with the remote device. The instructions further enable the processor receive the message over a second interface of the host and compare the address associated with the remote device to a value stored in an address field on a storage unit. The instructions further enable the processor to store the address associated with the remote device in the address field in response to determining that the address associated with the remote device is not substantially equal to the value stored in the address field and transmit a response to the remote device in response to determining that the address associated with the remote device is not substantially equal to the value stored in the address field, wherein the response includes the address associated with the host.

### BRIEF DESCRIPTION OF THE DRAWINGS

The invention may be understood by reference to the following description taken in conjunction with the accompanying drawings, in which like reference numerals identify like elements.

FIG. 1 is a block diagram of an embodiment of a communications system, in accordance with the present invention.

FIG. 2 illustrates a format of a Virtual IP Address (VIPA) structure that may be employed in the communications system of FIG. 1, in accordance with one embodiment of the present invention.

FIG. 3 depicts a flow chart of one aspect of an Address Resolution (AR) module that may be implemented in FIG. 1, in accordance with one embodiment of the present invention.

FIG. 4 depicts a flow chart of another aspect of the AR module of FIG. 3 that may be implemented in FIG. 1, in accordance with one embodiment of the present invention.

FIG. 5 illustrates a block diagram of a processor-based device that may be employed in the communications system of FIG. 1, in accordance with one embodiment of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

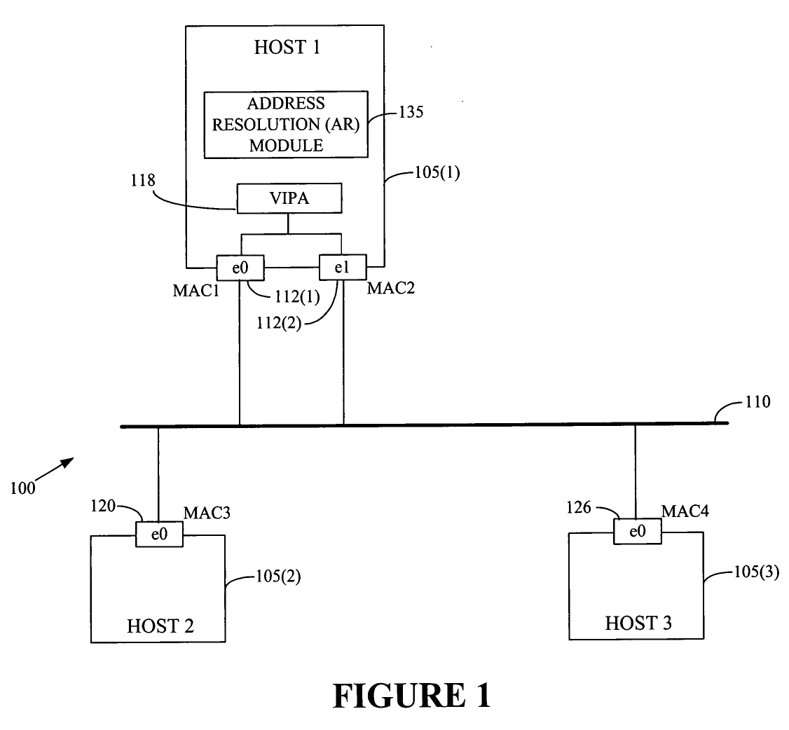

Referring to FIG. 1, a communications system 100 is illustrated in accordance with one embodiment of the present invention. The communications system 100 includes a plurality of hosts 105(1-3) that are communicatively coupled to each other by a network 110, such as a private network or a public network (e.g., the Internet). For illustration purposes, three hosts 150(1-3) are shown in FIG. 1, although in alternative embodiments, the communication system 100 may include more or fewer hosts. In the illustrated embodiment, the first host 105(1) is a multi-homed host that includes a plurality of interfaces 112(1-2) through which the first host 105(1) can communicate with other hosts 115(2-3) coupled to the network 110. Although not so limited, the second and third hosts 105(2-3) are shown each having a respective interface 120, 126. In one embodiment, each interface 112(1-2), 120, 126 may be a physical network adapter, such as an Ethernet network adapter. Each interface 112(1-2), 120, 126 has an associated Medium Access Control (MAC) address, which, for ease of illustration, is labeled in FIG. 1 as MAC1, MAC2, MAC3, and MAC4, respectively.

The first host 105(1) includes a virtual IP address (VIPA) 118 associated with both the first and second interface 112(1-2). Further, the first host 105(1) includes an address resolution (AR) module 135 that, in accordance with one embodiment of the present invention, efficiently manages Address Resolution Protocol (ARP) requests received from other hosts 105(2-3). The ARP is a protocol used by the Internet Protocol (IP) to map IP network addresses to the hardware addresses used by a data link protocol. The ARP protocol operates below the network layer as a part of the interface between the OSI network and OSI link layer.

The network 110 of FIG. 1 may be a packet-switched data network. In the illustrated embodiment, the network 110 is a data network according to the Internet Protocol/Transport Control Protocol (TCP/IP) and/or User Datagram Protocol (UDP). Examples of the network 110 may include local area networks (LANs), wide area networks (WANs), intranets, and the Internet. One version of IP is described in Request for Comments (RFC) 791, entitled “Internet Protocol,” dated September 1981, and a version of TCP is described in RFC 793, entitled “Transmission Control Protocol,” dated September 1981. Other versions of IP, such as IPv6, or other connectionless, packet-switched standards may also be utilized in further embodiments. A version of IPv6 is described in RFC 2460, entitled “Internet Protocol, Version 6 (IPv6) Specification,” dated December 1998. A version of UDP is described in RFC 768, entitled “User Datagram Protocol,” dated August 1980. The data network 110 may also include other types of packet-based data networks in further embodiments. Examples of such other packet-based data networks include Asynchronous Transfer Mode (ATM), Frame Relay networks and the like.

It should be appreciated that the arrangement of the communications system 100 of FIG. 1 is exemplary in nature and that, in alternative embodiments, the network 110 may include any desirable number of devices, including hosts 105, such as the multi-homed host 105(1). The communication system 100 may also include routers (not shown) that facilitate communication between hosts 105 located on different subnets (or prefixes). The hosts 105(1-3) may each be any suitable type of processor-based device, such as a desktop computer, laptop computer, a mainframe, a portable device, a kiosk, a Web appliance, and the like.

The AR module 135 illustrated in FIG. 1 is implemented in software, although in other implementations these modules may also be implemented in hardware or a combination of hardware and software. In one embodiment, the AR module 135 may comprise a plurality of modules, with each of the plurality of modules capable of performing one or more desired acts. Some or all portions of the AR module 135 may be implemented at the same level as (or in the) the operating system's kernel (or in the network subsystem of the operating system).

The hosts 105(1-3) can communicate with each other upon discovering the MAC address of the remote host 105. For example, if an originating host 105 desires to communicate with a destination host 105, the originating host 105 broadcasts an ARP request with an IP address (or a virtual IP address) of the target host 105 in a destination field of the ARP request to all the other hosts 105 on the network 110. Each recipient host 105 on the same subnet (or prefix) as the originating host 105 receives the ARP request to determine if the IP address in the destination field is associated with any of its physical interfaces (e.g., 112(1-2), 120, 126). If the IP address is not associated with a host 105, then that ARP is silently discarded by that host 105. If, on the other hand, the IP address in the ARP request is associated with a host 105, then that host 105 responds to the originating host 105 with its MAC address.

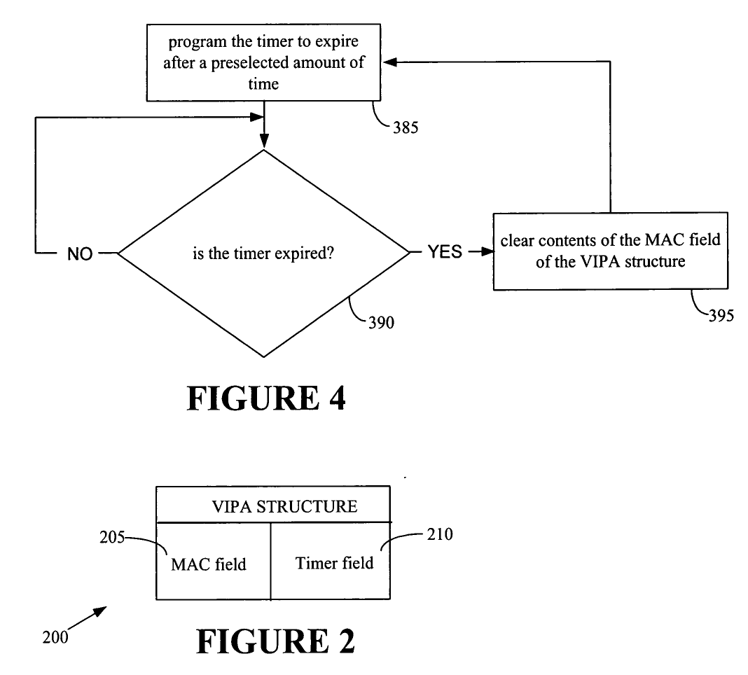

Because the first host 105(1) includes two interfaces 112(1-2), the originating host (e.g., host 105(2) or 105(3)) would ordinarily receive two replies each time, one from each interface 112(1-2). However, as described below, the AR module 135 provides for an improved manner of handling ARP requests that are received from other hosts 105(2-3). In one embodiment, the AR module 135 employs a VIPA structure 200, shown in FIG. 2, to track the MAC address of the last host 105(2-3) that originated the ARP request to reduce the number of duplicate ARP replies that are transmitted by the AR module 135.

The VIPA structure 200, in the illustrated embodiment of FIG. 2, includes a MAC field 205 for storing the MAC address of the last host 105(2-3) that originated the ARP request, and a timer field 210 for storing a programmable value at the expiration of which the contents of the MAC field 205 are cleared. As explained later, based on the MAC address stored in the MAC field 205 of the VIPA structure 200, the AR module 135 determines whether to reply to an ARP request. The VIPA structure 200 may be stored in a storage unit (not shown) in the first host 105(1) at any desirable location that is accessible by the AR module 135.

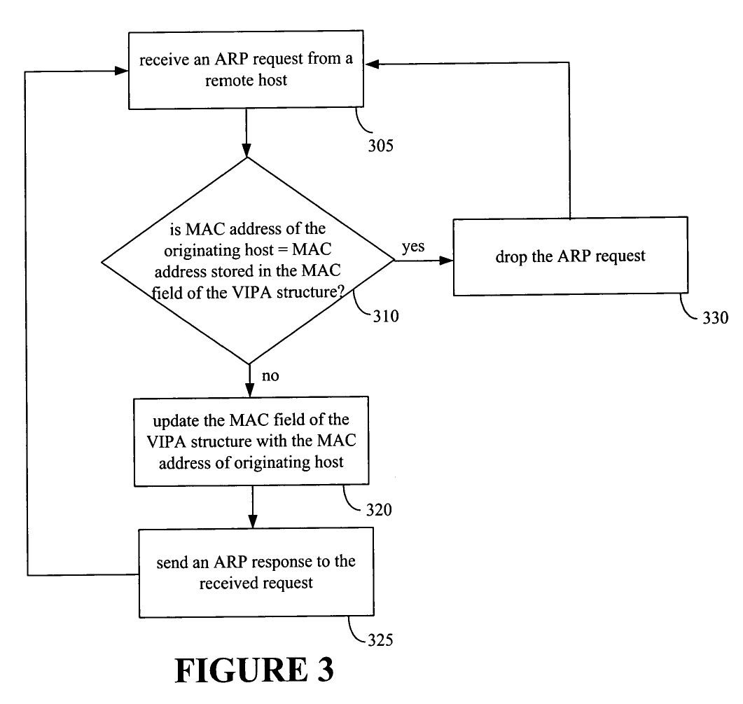

Referring now to FIG. 3, a flow diagram of one aspect of the AR module 135 of FIG. 1 is illustrated, in accordance with one embodiment of the present invention. For ease of illustration, the flow diagram of the AR module 135 is discussed in the context of the communications system 100 of FIG. 1. For illustrative purposes, it is herein assumed that the third host 105(3) broadcasts an ARP request with the VIPA 118 of the first host 105(1) stored in the destination field of the ARP request. The host 105 that transmits the ARP request is referred to as the “originating” host. The originating host 105(3) includes its own MAC address (e.g., MAC4) in the ARP request.

The ARP request transmitted by the third host 105(3) is received by the other hosts that are on the same subnet (or prefix) as the third host 105(3), including the first host 105(1) and the second host 105(2). Because the VIPA 118 is not associated with the second host 105(2), the second host 105(2) silently discards it. But because the VIPA 118 is associated with both the first interface 112(1) and the second interface 112(2) of the first host 105(1), the ARP request is received and processed by each interface 112(1-2) according to the flow diagram of the AR module 135 described in FIG. 3.

The AR module 135 processes the ARP request for each of the interfaces 112(1-2) of the first host 105(1). The flow diagram of FIG. 3 is first described with respect to the first interface 112(1) of the first host 105(1). The AR module 135 of the first host 105(1) receives (at 305) the ARP request from the remote host (which in this example is the third host 105(3)) over the first interface 112(1). As noted, the received ARP request includes the MAC address (e.g., MAC4) of the originating host 105(3). The AR module 135 determines (at 310) if the MAC address of the originating host 105(3) is equal to the address stored in the MAC field 205 (see FIG. 2) of the VIPA structure 200. As utilized herein, the term “equal” includes substantially equal. Thus, the two addresses need not necessarily be identical but rather substantially equal, in one embodiment.

Because the contents of the MAC field 205 are initially empty, the MAC address of the originating host 105(3) will not be equal to the value stored in the MAC field 205 of the VIPA structure 200. As such, the AR module 135 updates (at 320) the MAC field 205 of the VIPA structure 200 with the MAC address of the originating host 105(3). Thus, in this example, the MAC field 205 will contain MAC4, the MAC address of the third host 105(3).

The AR module 135 sends (at 325) an ARP response to the originating host 105(3) based on the received ARP request (at 305). The ARP response will include the MAC address (e.g., MAC1) of the first interface 112(1) of the responding host, which in this case is the first host 105(1). It should be appreciated that, in an alternative embodiment, the AR module 135 may send (at 325) the ARP response and then update (at 320) the MAC field 205 of the VIPA structure 200. That is, one or more of the acts described in FIG. 3 may be performed out of order in any manner.

Upon receiving the ARP response, the originating host 105(3) can update its ARP table (not shown) with the MAC address associated with the first interface 112(1) of the first host 105(1), and then establish a communication session with the first host 105(1) to exchange data. In one embodiment, the first host 105(1) can utilize both interfaces 112(1-2) to communicate with the originating host 105(3) once a communication session is established.

The flow diagram of FIG. 3 is now described with respect to the second interface 112(2) of the first host 105(1). Because the second interface 112(2), like the first interface 112(1), is also associated with the VIPA 118, the ARP request transmitted by the third host 105(3) is also received (at 305) by the second interface 112(2) of the first host 105(1). The AR module 135 determines if the MAC address of the originating host 105(3) is equal to the MAC address stored in the MAC field 205 of the VIPA structure 200. In this case, because the MAC address (e.g., MAC4) of the third host 105(3) was previously stored by the AR module 135 when processing the ARP request that was received over the first interface 112(1), the MAC address of the originating host 105(3) will equal to the address stored in the MAC field 205 of the VIPA structure 200. A match of the two addresses is an indication that this ARP request has already been replied to, and that a duplicate response by the second interface 112(2) is not desired or no longer necessary. As such, the AR module 135 does not respond (at 330) to the ARP request from the originating host 105(3). The AR module 135 silently drops the ARP request in this case. Accordingly, by tracking the MAC address of the originating host 105(3), the AR module 135 is able to reduce the number of duplicate replies that are sent in response to the ARP request.

The flow diagram of FIG. 3 is described in the context of the first interface 112(1) of the host 105(1) receiving and processing the ARP request before the second interface 112(2) processes that ARP request. It should, however, be appreciated that the order in which the interfaces 112(1-2) process the ARP request may vary. As such, in one embodiment, the second interface 112(2) may process the ARP request before the first interface 112(1). In this case, the AR module 135 may discard the ARP request received over the first interface 112(1) if it determines that a response has been sent to the originating host 105 based on the request received over the second interface 112(2). Thus, the general operation of the AR module 135 remains substantially the same, regardless of which ARP request is processed first.

Now assume that the second host 105(2) (instead of the third host 105(3)) desires to communicate with the first host 105(1), and, as such, the second host 105(2) transmits an ARP request with the VIPA 118 of the first host 105(1) stored in the destination field of the ARP request. The AR module 135 receives (at 305) this ARP request over its interfaces 112(1-2). The AR module 135 determines (at 310) if the MAC address of the origination host (the second host 105(2) this time) is equal to the MAC address stored in the MAC field 205 of the VIPA structure 200. In this case, the MAC field 205 contains the MAC address of the third host 105(3)) (e.g., MAC4). As such, the comparison (at 310) will fail because the MAC address of the originating host is MAC3 (the address of the second host 105(2)) and the value stored in the MAC field 205 is MAC4. A failed comparison is an indication that the AR module 135 may need to respond to the received ARP request. Accordingly, in this example, the AR module 135 sends (at 325) an ARP response to the originating host 105(2) after updating (at 320) the MAC field 205 of the VIPA structure 200 with the MAC address of the originating host 105(2).

FIG. 4 illustrates a flow diagram of another aspect of the AR module 135, in accordance with one embodiment of the present invention. The AR module 135 in the illustrated embodiment clears the contents of the MAC field 205 of the VIPA structure 200 based on the timer value stored in the timer field 210 (see FIG. 4) of the VIPA structure 200. In one embodiment, the flow diagram shown in FIG. 4 may be implemented to execute as a background process or may be implemented as part of an interrupt routine. In FIG. 4, the AR module 135 programs (at 385) a timer to expire after a preselected amount of time. The preselected time may be a programmable value that is storable in the timer field 210 of the VIPA structure 200. In an alternative embodiment, a fixed, non-programmable timer value may be employed, if desired. In one embodiment the preselected time value stored in the timer field 210 may be 5 seconds, although in other embodiments this value may vary from one implementation to another.

The AR module 135 determines (at 390) if the timer has expired. If the timer has not expired, the AR module 135 may repeatedly check (at 390) until the timer has expired. In one embodiment, a delay may be introduced before the AR module 135 iteratively checks to determine (at 390) if the timer has expired. Any variety of timers may be employed, including a timer feature available through the operating system of the host device 105(1).

If the AR module 135 determines (at 390) that the timer has expired, the AR module 135 clears (at 395) the contents of the MAC field 205 of the VIPA structure 200. It may be desirable to clear the contents of the MAC field 205 after the preselected amount of time to reduce the possibility of not responding to a legitimate ARP request that originates from a host 105 whose MAC address was previously stored in the MAC field 205 of the VIPA structure 200. For example, if for some reason, the MAC address associated with the first host 105(1) is deleted from the third host 105(3), the third host 105(3) may need to transmit another ARP request to the first host 105(1) to obtain at least one of its associated MAC address. However, if the MAC address of the third host 105(3) is stored in the MAC field 205 from a previous transaction, the AR module 135 may not respond to the subsequent ARP request from the third host 105(3). Thus, to reduce the possibility of not responding to the ARP request in the above scenario, the AR module 135 occasionally clears (at 395) the contents of the MAC field 205 to allow the first host 105(1) to respond to the originating host 105(3).

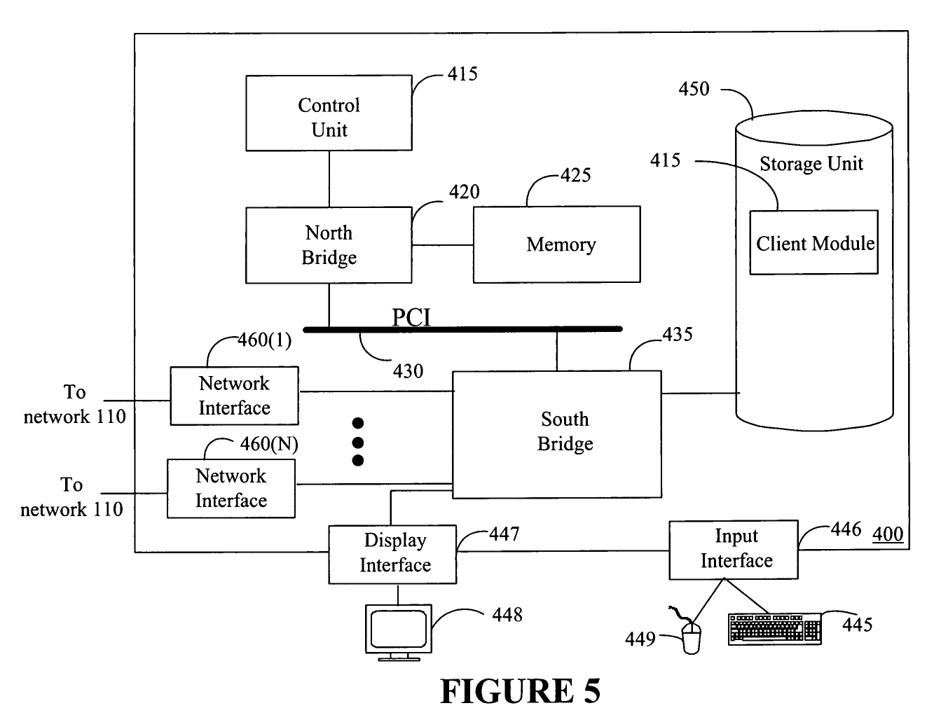

Referring now to FIG. 5, a stylized block diagram of a processor-based device 400 that may be implemented in the communications system of FIG. 1 is illustrated, in accordance with one embodiment of the present invention. That is, the processor-based device 400 may represent one embodiment of the multi-homed host 105(1). The processor-based device 400 comprises a control unit 415, which in one embodiment may be a processor that is capable of interfacing with a north bridge 420. The north bridge 420 provides memory management functions for a memory 425, as well as serves as a bridge to a peripheral component interconnect (PCI) bus 430. In the illustrated embodiment, the processor-based device 400 includes a south bridge 435 coupled to the PCI bus 430.

A storage unit 450 is coupled to the south bridge 435. The AR module 135 may be storable in the storage unit 450, and can be executable by the control unit 415. Although not shown, it should be appreciated that in one embodiment an operating system, such as Windows®, Disk Operating System®, Unix®, OS/2®, Linux®, MAC OS®, or the like, may be stored on the storage unit 450 and executable by the control unit 415. The storage unit 450 may also include device drivers for the various hardware components of the processor-based device 400.

In the illustrated embodiment, the processor-based device 400 includes a display interface 447 that is coupled to the south bridge 435. The processor-based device 400 may display information on a display device 448 via the display interface 447. The south bridge 435 of the processor-based device 400 may include a controller (not shown) to allow a user to input information using an input device, such as a keyboard 445 and/or a mouse 449, through an input interface 446.

The south bridge 435 of the processor-based device 400, in the illustrated embodiment, is coupled to one or more network interfaces 460(1-N), which may be adapted to receive, for example, local area network cards. The processor-based device 400 communicates with other devices coupled to the network 110 through the network interfaces 460(1-N). Although not shown, associated with the network interface 460(1-N) may be a network protocol stack, with one example being a UDP/IP (User Datagram Protocol/Internet Protocol) stack. In one embodiment, both inbound and outbound packets may be passed through the network interface 460(1-N) and the network protocol stack.

In one embodiment, the processor-based device 400 may also represent the second host and/or third host 105(2-3) of FIG. 1. In one embodiment, if the processor-based device 400 is implemented as second and third hosts 105(2-3), the AR module 135 may or may not be stored in the storage unit 450. Additionally, the processor-based device 400 may include, if desired, a single network interface 460 instead of a plurality of interfaces 460(1-N).

It should be appreciated that the configuration of the processor-based device 400 of FIG. 5 is exemplary in nature and that, in other embodiments the processor-based device 400 may include fewer, additional, or different components without deviating from the spirit and scope of the present invention. For example, in an alternative embodiment, the processor-based device 400 may not include a north bridge 420 or a south bridge 435, or may include only one of the two bridges 420, 435, or may combine the functionality of the two bridges 420, 435. As another example, in one embodiment, the processor-based device 400 may include more than one control unit 415. Similarly, other configurations may be employed consistent with the spirit and scope of the present invention.

The various system layers, routines, or modules may be executable control units (such as control unit 415 (see FIG. 5)). The control unit 415 may include a microprocessor, a microcontroller, a digital signal processor, a processor card (including one or more microprocessors or controllers), or other control or computing devices. The storage devices 450 referred to in this discussion may include one or more machine-readable storage media for storing data and instructions. The storage media may include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy, removable disks; other magnetic media including tape; and optical media such as compact disks (CDs) or digital video disks (DVDs). Instructions that make up the various software layers, routines, or modules in the various systems may be stored in respective storage devices 450. The instructions when executed by a respective control unit 415 cause the corresponding system to perform programmed acts.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method, comprising:
receiving a message transmitted by a remote device to a host, wherein the message includes a request to provide a value representative of an address associated with the host and wherein the message includes a value representative of an address associated with the remote device;
comparing at least a portion of the value representative of the address associated with the remote device to a value stored in an address field on a storage unit; and
discarding the message in response to determining that at least the portion of the value representative of the address associated with the remote device is substantially equal to the value stored in the address field.

2. The method of claim 1, wherein the value representative of the address associated with the host comprises a medium access layer (MAC) address associated with the host, wherein the value representative of the address associated with the remote device comprises a MAC address associated with the remote device, and wherein receiving a message comprises receiving an Address Resolution Protocol (ARP) message.

3. The method of claim 2, wherein the host comprises at least a first interface and a second interface that are both associated with a common Virtual Internet Protocol Address (VIPA), wherein receiving the message comprises receiving the message transmitted over the first interface of the host and receiving the message over the second interface of the host, and wherein the message includes the VIPA address associated with the host.

4. The method of claim 3, wherein receiving the message over the first interface further comprises storing the MAC address associated with the remote device in the address field in response to determining that the MAC address associated with the remote device is not substantially equal to the value stored in the address field.

5. The method of claim 1, further comprising transmitting a response to the remote device in response to determining that at least the portion of the value representative of the address associated with the remote device is not substantially equal to the value stored in the address field.

6. The method of claim 1, further comprising clearing the content of the address field at a preselected time interval.

7. The method of claim 6, wherein the preselected time interval is a configurable time interval, and wherein clearing the content comprises removing the contents of the address field at each configurable time interval.

8. An article comprising one or more machine-readable storage media containing instructions that when executed enable a processor to:
receive a message transmitted by a remote device over a first interface of a host, wherein the message includes a request to provide an address associated with the host and wherein the message includes an address associated with the remote device;
receive the message over a second interface of the host;
compare the address associated with the remote device to a value stored in an address field on a storage unit;
store the address associated with the remote device in the address field in response to determining that the address associated with the remote device is not substantially equal to the value stored in the address field; and
transmit a response to the remote device in response to determining that the address associated with the remote device is not substantially equal to the value stored in the address field, wherein the response includes the address associated with the host.

9. The article of claim 8, wherein the instructions when executed enable the processor to discard the message received over the second interface in response to determining that the address associated with the remote device is substantially equal to the value stored in the address field.

10. The article of claim 8, wherein the first and the second interface are both associated with a Virtual Internet Protocol Address (VIPA), and wherein the instructions when executed enable the processor to receive the message according to the Address Resolution Protocol (ARP), and wherein the message is a broadcast message from the remote host.

11. The article of claim 8, wherein the instructions when executed enable the processor to compare the address associated with the remote device to the value stored in the address field based on the message received over the first interface.

12. The article of claim 8, wherein the instructions when executed enable the processor to at least one of transmit data to and received data from the remote device based on transmitting the response to the remote device.

13. The article of claim 8, wherein the instructions when executed enable the processor to clear the content of the address field at a preselected time interval.

14. An apparatus, comprising:
at least a first interface and a second interface; and
a control unit adapted to:
receive a message transmitted by a remote device to a host, wherein the message includes a request to provide a value representative of an address associated with the host and wherein the message includes a value representative of an address associated with the remote device;
compare at least a portion of the value representative of the address associated with the remote device to a value stored in an address field on a storage unit; and
discard the message in response to determining that at least the portion of the value representative of the address associated with the remote device is substantially equal to the value stored in the address field.

15. The apparatus of claim 14, wherein the value representative of the address associated with the host comprises a medium access layer (MAC) address associated with the host and wherein the value representative of the address associated with the remote device comprises a MAC address associated with the remote device, and wherein the control is adapted to receive an Address Resolution Protocol (ARP) message.

16. The apparatus of claim 15, wherein the first interface and the second interface are each associated with a common Virtual IP address, and wherein the control unit is adapted to receive the message transmitted over the first interface of the host and receive the message over the second interface of the host.

17. The method of claim 16, wherein the control unit is adapted to store the MAC address associated with the remote device in the address field in response to determining that the MAC address associated with the remote device is not substantially equal to the value stored in the address field.

18. The apparatus of claim 14, wherein the control unit is further adapted to transmit a response to the remote device in response to determining that at least the portion of the value representative of the address associated with the remote device is not substantially equal to the value stored in the address field.

19. The apparatus of claim 14, wherein the control unit is further adapted to clear the content of the address field at a preselected time interval.

20. The apparatus of claim 19, wherein the preselected time interval is a configurable time interval.
